(19) United States
(12) Patent Application Publication
(10) Pub. No.: US 2015/0321277 A1
(43) Pub. Date: Nov. 12, 2015

(54) DIELECTRIC FLUID FOR ELECTRIC DISCHARGE MACHINING

(71) Applicant: BUCHER AG LANGENTHAL, Langenthal (CH)

(72) Inventors: Peter REGENASS, Langenthal (CH); Marco BOCCADORO, Versico (CH); Alan HENDERSON, Hinterfingen (CH)

(73) Assignee: BUCHER AG LANGENTHAL, Langenthal (CH)

(21) Appl. No.: 14/647,050

(22) PCT Filed: Jan. 22, 2014
(86) PCT No.: PCT/CH2014/000008

§ 371 Date: May 22, 2015

(30) Foreign Application Priority Data
Jan. 29, 2013 (CH) 00353/13

(51) Int. Cl. B23H 1/08; H01B 3/22

(52) U.S. Cl. CPC B23H 1/08; H01B 3/22

(57) ABSTRACT

A dielectric fluid composition for electric discharge machining is based on saturated hydrocarbons and contains an additive wherein the additive comprises at least one carboxylic acid or a glycerol ester of a carboxylic acid and at least one amine. Preferably, the additive comprises tall oil fatty acids (TOFA). The saturated hydrocarbons have a low content of aromatic hydrocarbons, which is less than 1% w/w. The additive is present in concentrations from 1 to 25%, preferably 5 to 15% by weight in the dielectric fluid. The additive is soluble in the saturated hydrocarbon basis.

### TECHNICAL FIELD

The invention relates to a dielectric fluid composition for electric discharge machining based on saturated hydrocarbons and containing an additive. Further, it relates to the process of electric discharge machining using such a dielectric fluid composition.

### BACKGROUND ART

An electrical discharge machining (EDM) process is a manufacturing process particularly useful for products of complex or irregular shape or fragile structure. It is also known as spark machining, spark eroding, burning, die sinking (with an electrode as a tool) or wire erosion using a wire as a cutting tool.

In general, an object with a desired shape is obtained by controlled removal of material from the surface of an electrically conductive workpiece. A spark discharge is produced by controlled pulsing of direct current between the workpiece and a tool which might be an electrode or a wire. The electrode and the workpiece are separated by a narrow working gap and are surrounded by a dielectric fluid. When applying high voltage an electrical discharge takes place between the workpiece and the tool, thereby generating heat at the surface of the workpiece. By each spark enough heat is produced to melt or vaporize a small quantity of the workpiece material, generating a tiny pit or crater on the surface. Overall, drilling, cutting or shaping can be carried out by EDM.

The dielectric fluid has several important functions. It has to isolate the workpiece from the electrode, and the electrical discharge should take place when the gap is as small as possible. This may enhance the removal rate and the copying accuracy, if an electrode is used as a tool. In addition, the dielectric fluid serves as a spark conductor as it has to restrict the discharge channel in order to achieve a high energy density. Further it is a coolant for the electrodes and removes the small particles of material separated from the workpiece. In general, a dielectric fluid has low conductivity.

It is desired to obtain workpieces with a high precision and a low surface roughness.

These characteristics are affected by the achievable gap width d, which is inversely proportional to the capacitance C of the tool. By applying voltage to the system, unwanted current spikes occur, proportional to the capacitance. The current spikes worsen the surface roughness and increase the electrode wear. To improve the surface quality it is known in the state of the art to reduce this unwanted capacitance C by increasing the gap width d.

This may be accomplished by the addition of conductive additives to the dielectric fluid. However, the addition of solid additives (usually graphite particles with a diameter below 15 μm, but also aluminium or silicon) has a number of disadvantages. The gap variation is difficult to control because of the uneven distribution of the additives. In addition, it is necessary to stir the liquid continuously since the particles tend to settle down. The stirring may cause hydrodynamic effects that can disturb the EDM process, especially for high precision machining. The additive particles are difficult or impossible to filter and contaminate the liquid itself, since they bind to the metal debris resulting from the EDM process. Further, the particles diffuse all over the machine, making it difficult to clean the mechanics and resulting in a precision loss over time, and a reduced lifetime of the machine. The graphite powder can originate undesirable metallurgical structures in the polished surface due to the high carbon concentration on the melted material neighbourhood.

### SUMMARY OF THE INVENTION

It is the object of the invention to provide a dielectric fluid pertaining to the technical field initially mentioned, that allows for an enhanced and timesaving electric discharge machining process.

The solution of the invention is specified by the features of claim 1. According to the invention a dielectric fluid composition for electric discharge machining is provided. This dielectric fluid composition is based on saturated hydrocarbons and it contains an additive, which is at least one carboxylic acid or its glycerol ester and at least one amine. Further, the process for producing such a dielectric fluid composition, its use and the process of electric discharge machining using such a dielectric fluid composition are specified by the features of claims 14-18.

The inventive dielectric fluid comprising the described additive substantially improves surface roughness. Further, higher removal rates of the surface material can be achieved. In addition, the appearance of black flecking sometimes occurring in the spark erosion procedure is reduced.

The dielectric fluid is a composition comprising a base oil of saturated hydrocarbons, which usually is a mixture of linear or branched alkanes or cycloalkanes. The average chain length in the mixture determines the physical properties like melting point, boiling point, flash point and viscosity. Typical mixtures are light oils or kerosene. Alternatively, it may consist of a single compound.

The base oil has to be inert during the EDM process. In particular, it should remain unaffected by the electrical discharges. Also, it should not react with of oxygen or air, or with the removed metal particles. It is advantageous, if the base oil is colourless and transparent.

The dielectric fluid further comprises a conductivity additive, which contains at least one carboxylic acid with the functional group —COON and at least one amine —NRX. Alternatively, it might also be at least one glycerol ester of a carboxylic acid and at least one amine, The additive increases the electrical conductivity of the dielectric fluid.

Although the addition of a carboxylic acid already enhances the electrical conductivity, the further addition of at least one amine is favorable.

By increasing the electrical conductivity of the dielectric fluid, the gap width between the electrode and the workpiece is increased. By this, the capacitance C between the workpiece and the tool is reduced, and the surface roughness is substantially improved. With the inventive dielectric fluid it is possible to obtain values for the surface roughness Ra below 0.03 μm. Best achievable values for the surface roughness known from the state of the art are in the range of Ra=0.1 down to 0.03 μm.

Preferably, the additive comprises a third compound which is TOFA (tall oil fatty acids). TOFA can be obtained from crude tall oil, which is a by-product of the pulp process. As crude tall oil is a natural product, its composition may vary. Beside other substances it contains a significant proportion of fatty acids, mainly palmitic acid, oleic acid and linoleic acid. By fractional distillation of crude tall oil TOFA can be obtained, which consists mainly of oleic acid.

So in a preferred embodiment, a mixture of at least three compounds is added to the base oil of saturated hydrocarbons, namely at least one carboxylic acid or its glycerol ester, at least one amine and TOFA.

By addition of TOFA, the dielectric fluid is stabilized and its conductivity is improved. The miscibility of the used compounds is enhanced, suspended particles or slight deposits are dissolved, and phase separation is suppressed.

Preferably, the dielectric fluid composition has a low content of aromatic hydrocarbons. It is preferred, that the content is less than 1% w/w. Aromatic hydrocarbons are polarisable and may contribute to the conductivity in an unattended manner. In addition, higher concentrations of aromatic compounds are toxic and may harm a machine operator working with the dielectric fluid.

In a preferred dielectric fluid the additive is present in concentrations from 1 to 25% by weight in the dielectric fluid. In particular, the additive should be used in concentrations from 5 to 15% by weight. In this concentration range, a desired resistivity in a range of 1-100 MΩ·mm is obtained. A resistivity in a lower range results in an higher inter electrode gap and in reduced machining accuracy and enables DC arcing, because there is not enough time for the dielectric fluid to deionize between the current pulses. A resistivity in a higher range make higher voltage U necessary before discharging occurs (increasing the unwanted capacitive energy E=0.5·C·U² that would be discharged additionally to the programmed pulses worsening the surface quality), or, at equal voltage U, reduces the discharge gap to such an extent, that the electrodes capacitance increases and, again, unwanted capacitive discharges worsen the surface quality. Moreover, a very small gap is not desirable, since it makes it very difficult for the servo control of the machine to maintain the interelectrode gap constant. Also the process is short circuit prone, and the eroded particles cannot be easily evacuated. Therefore, resistance outside this range is not favourable.

It is favourable, that the at least one carboxylic acid or a glycerol ester of a carboxylic acid in the additive is soluble in the saturated hydrocarbon basis. The compound should be at least partially soluble, otherwise it cannot contribute to the lowered resistivity of the dielectric fluid. Insoluble particles have the disadvantage to clog the filter system and may cause undesirable structures on the surface of the workpiece.

The at least one carboxylic acid or the glycerol ester of the carboxylic acid is present in concentrations from 0.1 to 10% by weight in the dielectric fluid. Preferably, their concentration is 1-5% by weight.

In general, fatty acids can be used. It is preferred that the at least one carboxylic acid has a medium or long chain length with a number of carbon atoms between 8 and 24, e. g. octanoic acid (caprylic acid), nonanoic acid (pelargonic acid), decanoic acid (capric acid), undecanoic acid, dodecanoic acid (lauric acid), tridecanoic acid, tertradecanoic acid (myristic acid), pentadecanoic acid, hexadecanoic acid (palmitic acid), heptadecanoic acid (margaric acid), octadecanoic acid (stearic acid), nonadecanoic acid, eicosanoic acid (arachidic acid), heneicosanoic acid, docosanoic acid, tricosanoic acid or tetracosanoic acid. The carbon chain may be linear or branched. Such acids are soft, paraffin-like substances showing a good solubility in lipophilic solvents.

In particular, nonanoic acid, also called pelargonic acid, or the iso-nonanoic acid, which is a mixture of methyl branched isomers of a carboxylic acid with 9 C-atoms, is preferred.

It is also possible to use soluble short-chain fatty acids with chain length of C4 - C7, as butanoic acid (butyric acid), pentanoic acid (valeric acid), hexanoic acid (caproic acid), heptanoic acid or their branched isomers. However, they have a strong unpleasant odor. If their use is recommended, an odor-masking agent might be added.

Optionally the carboxylic acid is an unsaturated derivative with at least one double bond in the carbon chain, for example oleic acid, a mono-unsaturated omega-9 fatty acid. Other mono-unsaturated fatty acids are e. g. myristolenic acid, palmitoleic acid or sapienic acid. Fatty acids with more than one double bond are e. g. linoleic acid, an unsaturated carboxylic acid with two double bonds with cis-configuration, linoelaidic acid, a geometric isomer of linoleic acid, or arachidonic acid with four double bonds. But also other unsaturated carboxylic acids may be used.

Also the amine should be soluble in the saturated hydrocarbon basis to have the best effect on the conductivity of the dielectric fluid and to avoid solid particles. Preferably, the amine should be relatively unreactive towards carboxylic acids. Particularly preferred, the amine should not react with the carboxylic acid.

Particularly preferred, the amine is a secondary amine HNR₁R₂ with two organic substituents and one hydrogen, or a tertiary amine NR₁R₂R₃ with three organic substituents. The organic substituents R₁, R₂, R₃ may be the same or different, aliphatic or aromatic.

It is preferred, that the substituent Rₓ with x=1,2,3 is a linear or branched alkyl chain with one to six carbon atoms. Also cyclic substituents are possible. Additionally, the presence of hydroxy-groups in at least one of the substituents is preferred.

The following amines have been found to be particularly favorable: N,N-dicyclohexylamine, N,N-dibutylethanolamine, N,N-diisopropylmethylamine and N,N-diisopropanolmethylamine.

Other amines in combination with a suitable carboxylic acid may also enhance the conductivity of the dielectric fluid, however they have some disadvantages. N-methyl-diethanolamine gives a cloudy solution, while amino-2-propanol reacts with the carboxylic acid. Bis(2-hydroxypropyl)amine and 6-amino-1-hexanol is not or only slightly soluble in the saturated hydrocarbons.

Particularly preferred the amine is an alkylated derivative of diisopropanolamine. Most preferred it is N,N-diisopropanolmethylamine.

The amine is present in concentrations from 0.1 to 5%, preferably 1-2% by weight in the dielectric fluid.

In a preferred embodiment, TOFA is present in concentrations from 0.1 to 10% by weight in the dielectric fluid. Preferably, it is present in concentrations from 1 to 5% by weight.

A dielectric fluid according to the invention is produced in a very simple way providing a basis of saturated hydrocarbons and blending with the additive, wherein the additive comprises at least one carboxylic acid or a glycerol ester of a carboxylic acid and at least one amine. It is preferred to add the at least one carboxylic acid or a glycerol ester of a carboxylic acid and at least one amine successively to the basis of saturated hydrocarbons in any order.

In a special embodiment, it is also possible to pre-mix the at least one carboxylic acid or a glycerol ester of a carboxylic acid and at least one amine and to add this mixture to the basis of saturated hydrocarbons.

When using TOFA as a compound of the additive, it is preferred to add the three components, namely the at least one carboxylic acid or a glycerol ester of a carboxylic acid, at least one amine and TOFA separately, in any order, to a dielectric fluid. However, it is also possible to add TOFA to a dielectric fluid already comprising the at least one carboxylic acid or a glycerol ester of a carboxylic acid and at least one amine. Optionally. TOFA is blended in advance with the at least one carboxylic acid or a glycerol ester of a carboxylic acid and at least one amine. Then the additive, comprising at least three compounds, is blended with the basis of saturated hydrocarbons.

The described composition, which is a basis of saturated hydrocarbons with an additive, comprising at least one carboxylic acid or a glycerol ester of a carboxylic acid and at least one amine, is used as a dielectric fluid in electric discharge machining processes. As a result, objects with an improved surface roughness can be obtained. Manual polishing time, normally required to obtain desired surface quality, can be reduced, thereby reducing the production costs and time.

The use of a described composition comprising an additive with at least three components as a dielectric fluid for EDM is preferred. The three components of the additive are at least one carboxylic acid or a glycerol ester of a carboxylic acid, at least one amine and TOFA.

The process of electric discharge machining using a dielectric fluid composition can be performed on available EDM machines. However, an adjustment of the parameter is necessary.

Other advantageous embodiments and combinations of features come out from the detailed description below and the totality of the claims.

### PREFERRED EMBODIMENTS

A typical base oil is IME 110 with a density of about 0.78 g/cm³ at 15° C., viscosity of 3.4 mm²/s at 20° C. and a flash point at 106° C.

A first dielectric fluid composition (dielectric fluid 1) comprises 91% base oil (IME 110), 6% iso-nonanoic acid and 3% N,N-diisopropanolmethylamine. The total of the additive is 9%.

A second dielectric fluid composition (dielectric fluid 2) comprises 91% base oil (IME 110), 5% iso-nonanoic acid, 3% N,N-diisopropanolmethylamine and 1% TOFA. The total of the additive is 9%.

The following experiments were performed on a commercial EDM machine FORM 2000 HP available from GF Agie Charmilles, Geneva, Switzerland, comparing a standard dielectric fluid (IME 110) with the inventive dielectric fluid composition.

In a first experiment the same process parameters were applied, while aiming at a determined surface roughness Ra.

A workpiece made of W300 steel (a hot work tool steel) was processed by EDM using a Cu electrode with 25×25 mm size, using a) IME 110 as a standard dielectric fluid, and b) dielectric fluid 1.

TABLE 1
Comparison of dielectric fluids at constant process parameter

| | | |
|---|---|---|
| Aimed surface roughness Ra (μm) | 0.5 | 0.3 |
| Ra with IME 110 (μm) | 0.55 | 0.34 |
| Ra with dielectric fluid 1 (μm) | 0.39 | 0.21 |
| Improvement of surface roughness (%) | 29 | 38 |

When aiming at a surface roughness Ra=0.5 μm of the workpiece, a value of Ra=0.39 μm was obtained with dielectric fluid 1, while the standard dielectric fluid IME110 provided a value of about Ra=0.55 μm. When attempting a surface roughness Ra=0.3 μm, a value of Ra=0.21 μm was achieved with dielectric fluid 1 and of Ra=0.34 μm with the standard IME 110.

By changing the dielectric fluid only, while keeping the process parameters constant, the surface roughness Ra was improved by 29% and 38%, respectively.

In a second experiment, it was also shown, that a predetermined surface roughness Ra can be achieved in a shorter time period when using an inventive dielectric fluid composition.

A workpiece made of W300 steel (a hot work tool steel) was processed by EDM using a Cu electrode with 40×70×0.5 mm size, using a) IME 110 as a standard dielectric fluid, and b) dielectric fluid 2.

When using IME 110, the predetermined surface roughness Ra=0.5 μm was obtained after 5.5 h. The same surface roughness was obtained already after 4 h when using the inventive dielectric fluid, thereby accelerating the process by 27%.

Although described for die sinking EDM, the invention is not limited to this process only. The inventive dielectric fluid is also applicable in wire cutting EDM (WEDM) or drilling EDM.

In We sinking EDM, the electrode is moved as a negative form towards the workpiece. In wire cutting EDM a wire has the function of an electrode and it has the function of a cutter. A special form of die sinking EDM is drilling EDM. It is used to make a hole into a workpiece as a starting point for the wire for the following wire cutting EDM.

In summary, it is to be noted that a dielectric fluid composition is provided, which enables a higher performance in EDM processes.

1-18. (canceled)

19. A dielectric fluid composition for electric discharge machining based on saturated hydrocarbons and containing an additive whereby the additive comprises at least one carboxylic acid or a glycerol ester of a carboxylic acid and at least one amine.

20. A dielectric fluid composition according to claim 19, whereby the additive comprises tall oil fatty acids (TOFA).

21. A dielectric fluid composition according to claim 19, whereby the saturated hydrocarbons have a low content of aromatic hydrocarbons, which is less than 1% w/w.

22. A dielectric fluid composition according to claim 19, whereby the additive is present in concentrations from 1 to 25% by weight in the dielectric fluid.

23. A dielectric fluid composition according to claim 22, whereby the additive is present in concentrations from 5 to 15% by weight in the dielectric fluid.

24. A dielectric fluid composition according to claim 19, whereby the at least one carboxylic acid or a glycerol ester of a carboxylic acid is soluble in the saturated hydrocarbon basis.

25. A dielectric fluid composition according to claim 19, whereby the at least one carboxylic acid or the glycerol ester of the carboxylic acid is present in concentrations from 0.1 to 10% by weight in the dielectric fluid.

26. A dielectric fluid composition according to claim 25, whereby the at least one carboxylic acid or the glycerol ester of the carboxylic acid is present in concentrations from 1 to 5% by weight in the dielectric fluid.

27. A dielectric fluid composition according to claim 19, whereby the at least one carboxylic acid is a long chain carboxylic acid with a chain length between C8 (Octanoic acid) and C24 (Tetracosanoic acid).

28. A dielectric fluid composition according to claim 19, whereby the carboxylic acid is an unsaturated derivative with at least one double bond.

29. A dielectric fluid composition according to claim 19, whereby the amine is soluble in the saturated hydrocarbon basis.

30. A dielectric fluid composition according to claim 19, whereby the amine is a secondary or tertiary amine.

31. A dielectric fluid composition according to claim 19, whereby the amine is a derivative of diisopropanolamine.

32. A dielectric fluid composition according to claim 19, whereby the amine is present in concentrations from 0.1 to 5% by weight in the dielectric fluid.

33. A dielectric fluid composition according to claim 32, whereby the amine is present in concentrations from 1 to 2% by weight in the dielectric fluid.

34. A dielectric fluid composition according to claim 20, whereby the tall oil fatty acids (TOFA) is present in concentrations from 0.1 to 10% by weight in the dielectric fluid.

35. A dielectric fluid composition according to claim 34, whereby the tall oil fatty acids (TOFA) is present in concentrations from 1 to 5% by weight in the dielectric fluid.

36. A process for producing a dielectric fluid composition comprising the steps of providing saturated hydrocarbons as a basis and blending with an additive, wherein the additive comprises at least one carboxylic acid or a glycerol ester of a carboxylic acid and at least one amine.

37. A process for producing a dielectric fluid composition according to claim 36, whereby the additive comprises tall oil fatty acids (TOFA).

38. Use of a composition comprising saturated hydrocarbons and an additive, wherein the additive comprises at least one carboxylic acid or a glycerol ester of a carboxylic acid and at least one amine, as a dielectric fluid for electric discharge machining.

39. Use of a composition according to claim 38, whereby the additive comprises tall oil fatty acids (TOFA).

40. Process of electric discharge machining using a dielectric fluid composition according to claim 19.
